(19) United States
(12) Patent Application Publication
(10) Pub. No.: US 2021/0182542 A1
(43) Pub. Date: Jun. 17, 2021

(54) DETERMINING SENTIMENTS OF CUSTOMERS AND EMPLOYEES

(71) Applicant: Hewlett-Packard Development Company, L.P., Spring, TX (US)

(72) Inventor: King-Yan Lau, San Diego, CA (US)

(73) Assignee: Hewlett-Packard Development Company, L.P., Spring, TX (US)

(21) Appl. No.: 17/045,521

(22) PCT Filed: Sep. 7, 2018
(86) PCT No.: PCT/US2018/050076

§ 371 Date: Oct. 6, 2020

(51) Int. Cl. G06K 9/00; H04N 5/247; H04N 13/239; G06Q 20/20; G06Q 30/02

(52) U.S. Cl. CPC G06K 9/00335; H04N 5/247; G06K 9/00281; G06Q 30/0201; G06K 9/0061; G06K 9/00771; G06Q 20/202; H04N 13/239

(57) ABSTRACT

An example of an apparatus comprising a first and second camera to capture first visual data of a customer and an employee. A processor may execute machine-readable instructions to receive visual data from the cameras. Facial features may be identified in the visual data. Sentiments of the customer and employee may be determined based on the facial features.

### BACKGROUND

Stores may have point-of-sale terminals at the checkout lanes. An employee may operate the point-of-sale terminal, ringing up items being purchased by a customer. Interaction between the customer and employee may influence or reveal sentiments of the customer.

### BRIEF DESCRIPTION OF THE DRAWINGS

Various examples will be described below referring to the following figures:

FIG. 1 shows a point-of-sale analysis unit in accordance with various examples;

FIG. 2 shows a point-of-sale analysis unit with a network interface connector in accordance with various examples;

FIG. 3 shows a computer-readable medium with machine-readable instructions to analyze visual data in accordance with various examples;

FIG. 4 shows a computer-readable medium with machine-readable instructions to analyze visual data in accordance with various examples;

FIG. 5 shows a method of analyzing visual data and determining sentiment data of a customer and employee in accordance with various examples; and

FIG. 6 shows a method of analyzing visual data, determining sentiment data of a customer and employee, and associating sentiment data with transaction data in accordance with various examples.

### DETAILED DESCRIPTION

In a shopping experience, a customer may interact with an employee at a point of sale while checking out. Valuable data may be obtained by observing the interaction between the customer and employee.

A point-of-sale analysis unit may be coupled to a point-of-sale terminal to capture visual data of the customer and employee at the point of sale. The analysis unit may process the visual data to identify sentiment data of the customer and employee. The sentiment data may include information about whether the individual is happy, sad, or frustrated. Such data may enable a store to better serve its customers and employees. Analyzing the data at the point of sale may prevent privacy issues and bandwidth issues associated with transmitting such visual data to a remote location for analysis.

In one example in accordance with the present disclosure, an apparatus is provided. The apparatus comprises a first camera to capture first visual data of a customer, a second camera to capture second visual data of an employee, a processor coupled to the first camera and second camera, and a computer-readable medium coupled to the processor and storing machine-readable instructions that, when executed by the processor, cause the processor to receive the first visual data from the first camera, identify a first facial feature in the first visual data, determine first sentiment data based on the first facial feature, receive the second visual data from the second camera, identify a second facial feature in the second visual data, and determine second sentiment data based on the second facial feature.

In one example in accordance with the present disclosure, an apparatus is provided. The apparatus comprises a non-transitory computer-readable medium storing machine-readable instructions that, when executed by a processor, cause the processor to: receive first visual data of a customer from a first camera, receive second visual data of an employee from a second camera, identify a first facial feature in the first visual data, identify a second facial feature in the second visual data, determine first sentiment data based on the first facial feature, determine second sentiment data based on the second facial feature, and associate the first sentiment data with the second sentiment data.

In one example in accordance with the present disclosure, a method is provided. The method comprises receiving first visual data of a customer from a first camera, receiving second visual data of an employee from a second camera, identifying a first facial feature in the first visual data, identifying a second facial feature in the second visual data, determining first sentiment data based on the first facial feature, determining second sentiment data based on the second facial feature, associating the first sentiment data with the second sentiment data, and transferring the first and second sentiment data to a server via a network interface connector.

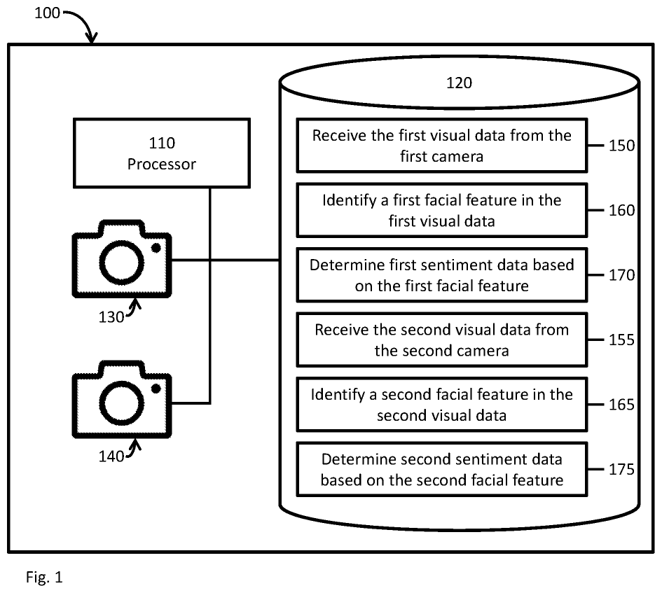

FIG. 1 shows a point-of-sale analysis unit 100 in accordance with various examples. The analysis unit 100 may include a processor 110, a computer-readable medium 120, and cameras 130, 140. The processor 110, computer-readable medium 120, and cameras 130, 140 may be coupled together via a bus.

Processor 110 may comprise a microprocessor, a microcomputer, a controller, a field programmable gate array (FPGA), or discrete logic to execute machine-readable instructions. Processor 110 may be part of a machine learning system for analyzing visual data to identify customer information, such as customer sentiment. The machine learning may be trained elsewhere and deployed for use with the analysis unit 100. This deployment may include execution of machine-readable instructions by the processor 110. The analysis unit 100 may include a housing, such as a two-part plastic shell that snaps together to enclose components. The processor 110, computer-readable medium 120, and cameras 130, 140 may be enclosed within the housing. The housing may have openings or clear portions to allow the cameras 130, 140 to obtain visual data of objects or individuals external to the housing.

Computer-readable medium 120 may be storage, such as a hard drive, solid state drive (SSD), flash memory, or electrically erasable programmable read-only memory (EEPROM). Computer-readable medium 120 may store machine-readable instructions 150, 155, 160, 165, 170, 175. Processor 110 may execute the machine-readable instructions 150, 155, 160, 165, 170, 175. Machine-readable instruction 150, when executed by the processor 110, may cause the processor 110 to receive the first visual data from the first camera. Machine-readable instruction 155, when executed by the processor 110, may cause the processor 110 to receive the second visual data from the second camera. Machine-readable instruction 160, when executed by the processor 110, may cause the processor 110 to identify a first facial feature in the first visual data. Machine-readable instruction 165, when executed by the processor 110, may cause the processor 110 to identify a second facial feature in the second visual data. Machine-readable instruction 170, when executed by the processor 110, may cause the processor 110 to determine first sentiment data based on the first facial feature. Machine-readable instruction 175, when executed by the processor 110, may cause the processor 110 to determine second sentiment data based on the second facial feature.

Cameras 130, 140 may capture still images or video. Cameras 130, 140 may include an optical zoom. Cameras 130, 140 may be able to change their directional facing or field of view, such as by using different lenses or motors to reposition the camera 130, 140. Changing the directional facing or field of view may allow cameras 130, 140 to track a moving individual or scan the surroundings.

The housing of the analysis unit 100 may be of any appropriate size or dimension. In various examples, the housing may be a rectangular prism encompassing a volume of two inches by two inches by eight inches. The housing may include holes along two different faces of the rectangular prism, though which the cameras 130, 140 collect visual data. The housing may be attachable to a point-of-sale terminal along a third face. Such attachment to a point-of-sale terminal may provide physical stability to the analysis unit to help prevent the collected visual data from being too blurry. The analysis unit may be set up so that one of the two cameras 130, 140 is pointed in the direction of an employee operating the point-of-sale terminal and the other of the two cameras 130, 140 is pointed in the direction of a customer being attended to at the point-of-sale terminal. The housing may also have an opening for a cord, such as a wired connection between the analysis unit 100 and the point-of-sale terminal. For example, the wired connection could be a universal serial bus (USB) connection.

In various examples, the analysis unit 100 may be placed at a point of sale so that camera 130 is pointed in the direction of a customer and camera 140 is pointed in the direction of an employee. The cameras 130, 140 may be capturing data while the point of sale is not in use. The analysis unit 100 may cause the cameras 130, 140 to limit acquisition of visual data based on various conditions. For example, the analysis unit 100 may receive a notification when the point of sale is being manned by an employee and cause the cameras 130, 140 to begin acquisition of data. The analysis unit 100 may receive a notification when a transaction has begun and cause the cameras 130, 140 to begin acquisition in response to the start of the transaction. The visual data may be processed in the analysis unit, such as by the processor 110, and discarded once the processing is complete or the transaction is over. This may be useful in addressing privacy concerns of customers, as the visual data may not be stored for an extended period of time or transmitted to another location and susceptible to interception.

When a customer is in the field of view of the camera 130, the analysis unit 100 may detect the customer. The processor 110 may identify shapes in the image that match potential facial features. The facial features may correspond to an eye, nose, mouth, eyebrow, tongue, or other parts of the customer. The processor 110 may identify the posture and position of arms and legs of the customer. The processor 110 may identify articles of clothing worn by the customer, such as a tie, blouse, t-shirt, coat, winter hat, or ball cap. Multiple customers may be within the field of view of the camera 130. The processor 110 may distinguish between the customers in identifying facial features and other characteristics of the customers and keep data regarding the two customers separate. The analysis unit 100 may detect the employee in view of camera 140 and identify facial features and other properties of the employee by processing the visual data.

In processing the visual data, the processor 110 may determine sentiment data of the customer and the employee based on the facial features. Sentiment data is information on the mood, disposition, emotion, or opinion of the individual. For example, the processor 110 may determine the customer and employee are happy based on the shape of their mouths and cheeks. The processor 110 may determine that a customer or employee is smiling but not happy, based on the mouth and eyes. The sentiment of the customer and employee may change throughout the transaction, with the processor 110 determining a new sentiment and when it changes. Such sentiment data may be marked with timestamps that may be useful in reconstructing a series of changes in sentiment data for the employee and customer. The sentiment data may be logged as part of tracking the transactions at the point-of-sale terminal. The sentiment data and transaction data may be transmitted to a server for further analysis.

Determining sentiment data may allow stores to improve their service. In various examples, sentiment data may be useful in determining when employee breaks or job rotations should be scheduled. Sentiment data may reveal that employees are happiest at the start of a shift, but experience a severe degradation in mood after more than three hours. Sentiment data may reveal that employees are happier after a break, but not after breaks for management instruction.

In various examples, sentiment data of customers may reveal times of day when customers are more likely to be angry and such anger may be due to long lines at checkout or may correspond to times of rush hour traffic. The store may respond by increasing the number of checkout lanes open at such times or scheduling shift changes so employees are refreshed and at their most helpful during such times. Sentiment data may be correlated with the transaction, such as determining a scowl on the customer's face when a certain product is rung up. Across multiple transactions, the store may be able to determine that customers are unhappy about the price of an item or that items are being rung up incorrectly.

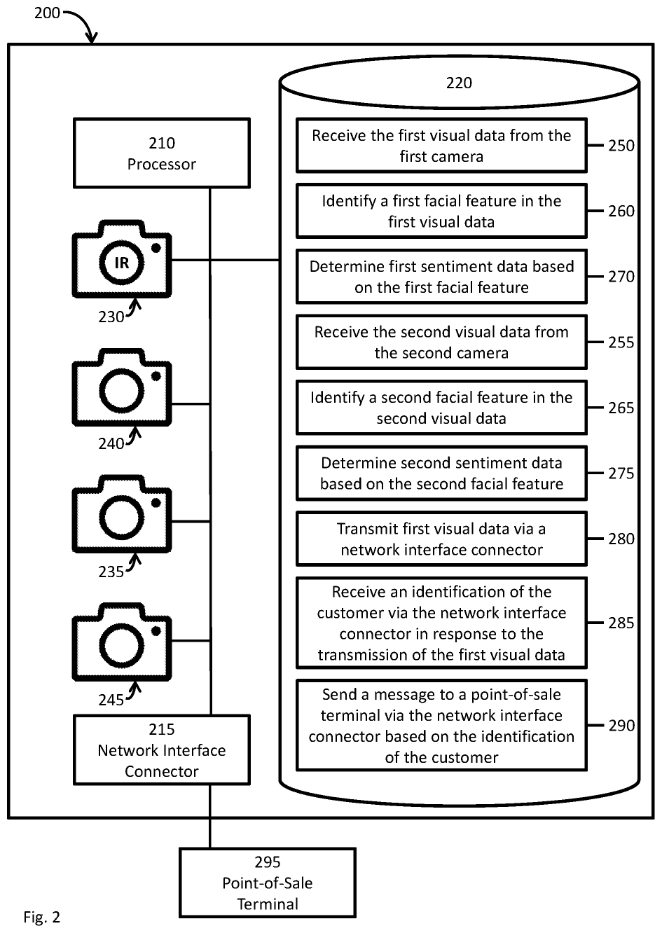

FIG. 2 shows a point-of-sale analysis unit 200 with a network interface connector 215 in accordance with various examples. The analysis unit 200 may include a processor 210, a computer-readable medium 220, cameras 230, 235, 240, 245, and a network interface connector 215. The analysis unit 200 may be coupled to a point-of-sale terminal 295 via the network interface connector 215.

Camera 230 may include an infrared camera. An infrared camera may be used to capture visual data of an individual's iris pattern of the individual's eye. The iris pattern may be used to determine the identity of a particular customer or employee. Cameras 230, 235 may be pointed in the direction of the customer. Cameras 240, 245 may be pointed in the direction of the employee. Use of multiple cameras covering overlapping fields of view may provide stereoscopic data. The stereoscopic data may provide information regarding distance of the objects from the cameras 230, 235, 240, 245, allowing capture of three dimensional visual data which may benefit the analysis performed by the analysis unit 200.

Network interface connector 215 may comprise a network device to provide an Ethernet connection, USB connection, wireless connection, or other connection. Network interface connector 215 may enable access to a bus on the point-of-sale terminal 295. Network interface connector 215 may enable access to a private corporate network. Network interface connector 215 may enable access to the Internet.

Point-of-sale terminal 295 may be a cash register. The point-of-sale terminal 295 may allow an employee to enter data regarding the transaction, such as an identification of items being purchased. The point-of-sale terminal 295 may be a collection of individual components, such as a tablet with a touch screen for entering orders, a credit card reader coupled to the tablet, and a printer for printing a receipt.

Computer-readable medium 220 may include machine-readable instructions 250, 255, 260, 265, 270, 275, 280, 285, 290. Machine-readable instruction 250, when executed by the processor 210, may cause the processor 210 to receive the first visual data from the first camera. Machine-readable instruction 255, when executed by the processor 210, may cause the processor 210 to receive the second visual data from the second camera. Machine-readable instruction 260, when executed by the processor 210, may cause the processor 210 to identify a first facial feature in the first visual data. Machine-readable instruction 265, when executed by the processor 210, may cause the processor 210 to identify a second facial feature in the second visual data. Machine-readable instruction 270, when executed by the processor 210, may cause the processor 210 to determine first sentiment data based on the first facial feature. Machine-readable instruction 275, when executed by the processor 210, may cause the processor 210 to determine second sentiment data based on the second facial feature. Machine-readable instruction 280, when executed by the processor 210, may cause the processor 210 to transmit first visual data via a network interface connector 215. Machine-readable instruction 285, when executed by the processor 210, may cause the processor 210 to receive an identification of the customer via the network interface connector 215 in response to the transmission of the first visual data. Machine-readable instruction 290, when executed by the processor 210, may cause the processor 210 to send a message to a point-of-sale terminal via the network interface connector 215 based on the identification of the customer.

In various examples, visual data or processed data may be transmitted to another location, such as a server, for further analysis and storage. The data may be anonymized, encrypted, or selected as to minimize privacy concerns. For example, the visual data may be limited to an image of the customer's eye, or the image of the customer's face may be processed into measurements, such as width of the nose, spacing of the eyes, and contour of the mouth. The server may compare the data against a database of customers. The database may be formed by enrollment of customers as members, which may include taking a picture of the customer. The identification of the customer, or a message indicating some action should be taken, may be sent back to the analysis unit 200. The analysis unit 200 may have an audio-visual indicator to notify the employee. The analysis unit 200 may send the identification of the customer or a message over the network interface connector 215 to the point-of-sale terminal 295. The employee may be notified of the name of the customer or special offers or rebates that should be offered to the customer. The notification may indicate a customer has been banned from the store so should not be serviced.

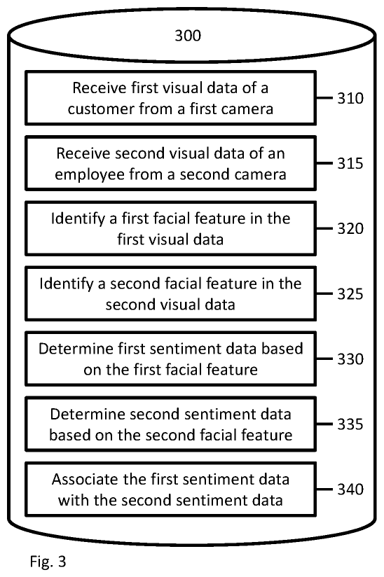

FIG. 3 shows a computer-readable medium 300 with machine-readable instructions 310, 315, 320, 325, 330, 335, 340 to analyze visual data in accordance with various examples. Machine-readable instruction 310, when executed by the processor, may cause the processor to receive first visual data of a customer from a first camera. Machine-readable instruction 315, when executed by the processor, may cause the processor to receive second visual data of an employee from a second camera. Machine-readable instruction 320, when executed by the processor, may cause the processor to identify a first facial feature in the first visual data. Machine-readable instruction 325, when executed by the processor, may cause the processor to identify a second facial feature in the second visual data. Machine-readable instruction 330, when executed by the processor, may cause the processor to determine first sentiment data based on the first facial feature. Machine-readable instruction 335, when executed by the processor, may cause the processor to determine second sentiment data based on the second facial feature. Machine-readable instruction 340, when executed by the processor, may cause the processor to associate the first sentiment data with the second sentiment data.

In various examples, the correlation of customer and employee sentiment data may be analyzed. The association of first sentiment data with second sentiment data may allow analysis of the interaction between the customer and the employee. The store may determine how quickly employees are affected by a customer's good or bad mood. The store may determine how long an employee can effectively handle an angry customer. In response, the analysis unit may prompt a manager to intervene and provide assistance.

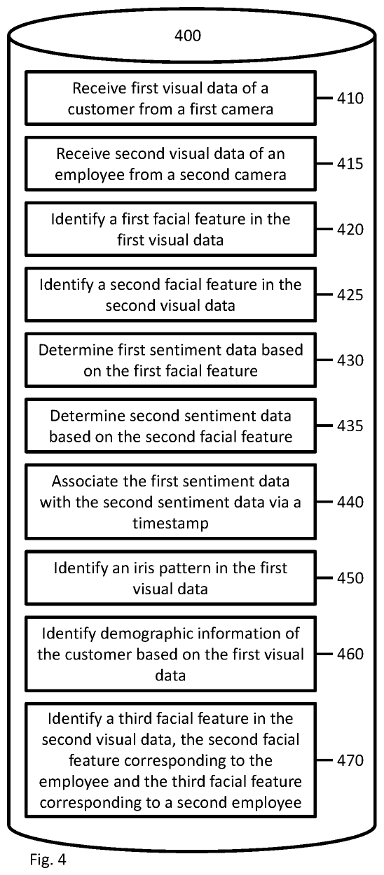

FIG. 4 shows a computer-readable medium 400 with machine-readable instructions 410, 415, 420, 425, 430, 435, 440, 450, 460, 470 to analyze visual data in accordance with various examples. Machine-readable instruction 410, when executed by the processor, may cause the processor to receive first visual data of a customer from a first camera. Machine-readable instruction 415, when executed by the processor, may cause the processor to receive second visual data of an employee from a second camera. Machine-readable instruction 420, when executed by the processor, may cause the processor to identify a first facial feature in the first visual data. Machine-readable instruction 425, when executed by the processor, may cause the processor to identify a second facial feature in the second visual data. Machine-readable instruction 430, when executed by the processor, may cause the processor to determine first sentiment data based on the first facial feature. Machine-readable instruction 435, when executed by the processor, may cause the processor to determine second sentiment data based on the second facial feature. Machine-readable instruction 440, when executed by the processor, may cause the processor to associate the first sentiment data with the second sentiment data via a timestamp. Machine-readable instruction 450, when executed by the processor, may cause the processor to identify an iris pattern in the first visual data. Machine-readable instruction 460, when executed by the processor, may cause the processor to identify demographic information of the customer based on the first visual data. Machine-readable instruction 470, when executed by the processor, may cause the processor to identify a third facial feature in the second visual data, the second facial feature corresponding to the employee and the third facial feature corresponding to a second employee.

In various examples, the visual data may be used to identify demographic information of a customer. Demographic information includes information such as the age, height, weight, gender, and race of the individual. Demographic information may be associated with the transaction information regarding which products are purchased in order to assist with devising advertising campaigns.

In various examples, a transaction may involve another employee, such as a manager. The manager may void a transaction entry, correct a price, or address a customer complaint. The second employee may be detected in the visual data by identifying a second facial feature belonging to the second employee. The sentiment of the second employee may also be determined and recorded. This may allow analysis of how often intervention by a manager results in an improved mood of the customer, as indicated by their sentiment. This may also allow analysis of how manager intervention affects the sentiment of employees.

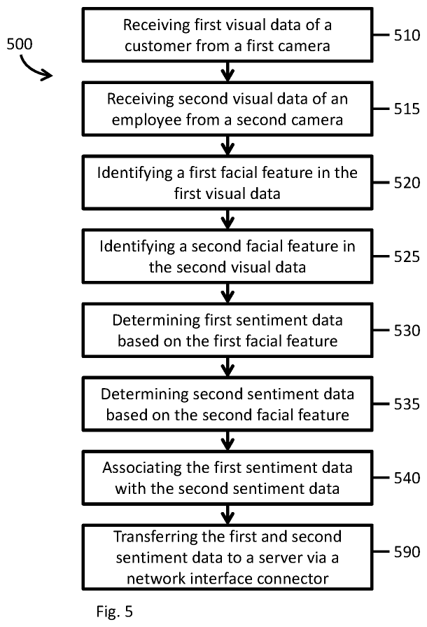

FIG. 5 shows a method 500 of analyzing visual data and determining sentiment data of a customer and employee in accordance with various examples. Method 500 may include receiving first visual data of a customer from a first camera 510. Method 500 may include receiving second visual data of an employee from a second camera 515. Method 500 may include identifying a first facial feature in the first visual data 520. Method 500 may include identifying a second facial feature in the second visual data 525. Method 500 may include determining first sentiment data based on the first facial feature 530. Method 500 may include determining second sentiment data based on the second facial feature 535. Method 500 may include associating the first sentiment data with the second sentiment data 540. Method 500 may include transferring the first and second sentiment data to a server via a network interface connector 590.

In various examples, data may be transferred from the point of sale to a server for further processing. The transferred data may include visual data for identification of a customer or employee. The transferred data may include processed data, such as demographic information and sentiment data. The transferred data may include information from the point-of-sale terminal, such as the items purchased and prices of the items.

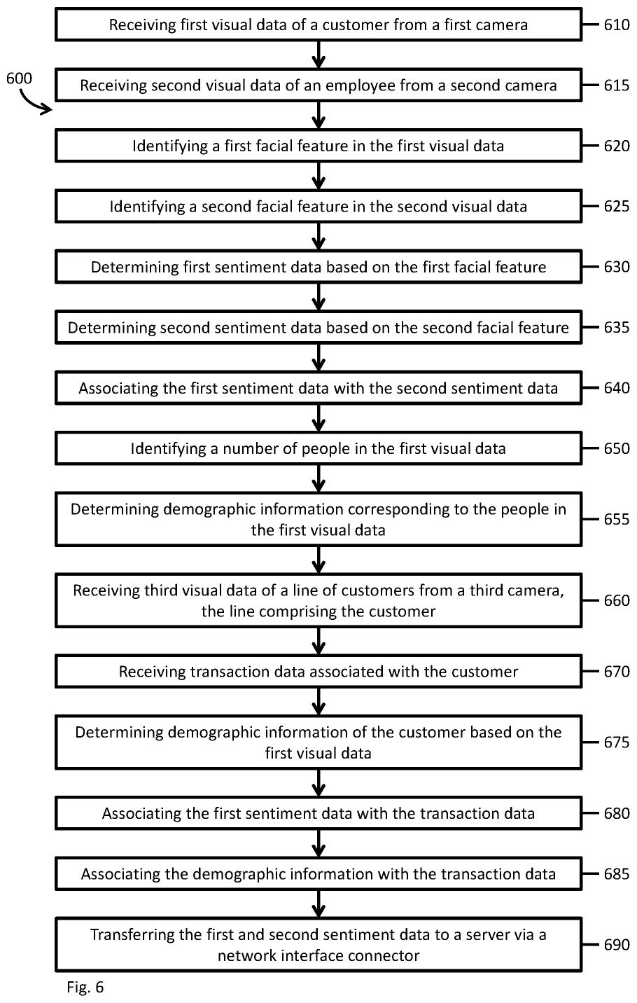

FIG. 6 shows a method 600 of analyzing visual data, determining sentiment data of a customer and employee, and associating sentiment data with transaction data in accordance with various examples. Method 600 may include receiving first visual data of a customer from a first camera 610. Method 600 may include receiving second visual data of an employee from a second camera 615. Method 600 may include identifying a first facial feature in the first visual data 620. Method 600 may include identifying a second facial feature in the second visual data 625. Method 600 may include determining first sentiment data based on the first facial feature 630. Method 600 may include determining second sentiment data based on the second facial feature 635. Method 600 may include associating the first sentiment data with the second sentiment data 640. Method 600 may include identifying a number of people in the first visual data 650. Method 600 may include determining demographic information corresponding to the people in the first visual data 655. Method 600 may include receiving third visual data of a line of customers from a third camera, the line comprising the customer 660. Method 600 may include receiving transaction data associated with the customer 670. Method 600 may include determining demographic information of the customer based on the first visual data 675. Method 600 may include associating the first sentiment data with the transaction data 680. Method 600 may include associating the demographic information with the transaction data 685. Method 600 may include transferring the first and second sentiment data to a server via a network interface connector 690.

In various examples, the camera pointed in the direction of the customer may acquire visual data of multiple individuals. The analysis of the visual data may recognize there are multiple individuals and determine sentiment data for the individuals.

In various examples, a camera may provide a view of the line forming at a checkout. The camera may be in the housing of the analysis unit. For example, the camera for viewing the line of the checkout may include a wide-angle lens and be pointed at a different angle than a camera intended to capture visual data of the customer currently being serviced at the checkout. The visual data of the checkout line may be analyzed to determine the number of people in line and how many different groups are represented. For example, children may be present in the line along with a parent, but the children may not be making a separate purchase. This information may be used to develop further demographic information about the customers, such as potential familial relationships and how that affects purchases. Data may be gathered regarding when the checkouts tend to be busy and assist in planning employee schedules.

The machine learning executed by the processor on an analysis unit may identify visual data for which sentiment data could not be accurately determined, or not determined with high confidence. Such visual data may be preserved and used to improve the machine learning for this and other analysis units.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An apparatus comprising:
a first camera to capture first visual data of a customer;
a second camera to capture second visual data of an employee;
a processor coupled to the first camera and second camera; and
a computer-readable medium coupled to the processor and storing machine-readable instructions that, when executed by the processor, cause the processor to:
receive the first visual data from the first camera;
identify a first facial feature in the first visual data;
determine first sentiment data based on the first facial feature;
receive the second visual data from the second camera;
identify a second facial feature in the second visual data; and
determine second sentiment data based on the second facial feature.

2. The apparatus of claim 1 comprising:
a third camera to capture third visual data of the customer; and
a fourth camera to capture fourth visual data of the employee, wherein the first and third visual data represent stereoscopic data of the customer and the second and fourth visual data represent stereoscopic data of the employee.

3. The apparatus of claim 1, wherein the first camera comprises an infrared camera.

4. The apparatus of claim 1, comprising a network interface connector, wherein the machine readable instructions, when executed by the processor, cause the processor to:
transmit first visual data via the network interface connector; and
receive an identification of the customer via the network interface connector in response to the transmission of the first visual data.

5. The apparatus of claim 4, wherein the machine readable instructions, when executed by the processor, cause the processor to send a message to a point-of-sale terminal via the network interface connector based on the identification of the customer.

6. A non-transitory computer-readable medium storing machine-readable instructions that, when executed by a processor, cause the processor to:
receive first visual data of a customer from a first camera;
receive second visual data of an employee from a second camera;
identify a first facial feature in the first visual data;
identify a second facial feature in the second visual data;
determine first sentiment data based on the first facial feature;
determine second sentiment data based on the second facial feature; and
associate the first sentiment data with the second sentiment data.

7. The computer-readable medium of claim 6 wherein the instructions, when executed by the processor, cause the processor to identify an iris pattern in the first visual data.

8. The computer-readable medium of claim 6, wherein the instructions, when executed by the processor, cause the processor to associate the first sentiment data with the second sentiment data via a timestamp.

9. The computer-readable medium of claim 6 wherein the instructions, when executed by the processor, cause the processor to identify demographic information of the customer based on the first visual data.

10. The computer-readable medium of claim 6 wherein the instructions, when executed by the processor, cause the processor to identify a third facial feature in the second visual data, the second facial feature corresponding to the employee and the third facial feature corresponding to a second employee.

11. A method comprising:
receiving first visual data of a customer from a first camera;
receiving second visual data of an employee from a second camera;
identifying a first facial feature in the first visual data;
identifying a second facial feature in the second visual data;
determining first sentiment data based on the first facial feature;
determining second sentiment data based on the second facial feature;
associating the first sentiment data with the second sentiment data; and
transferring the first and second sentiment data to a server via a network interface connector.

12. The method of claim 11 comprising identifying a number of people in the first visual data.

13. The method of claim 12 comprising determining demographic information corresponding to the people in the first visual data.

14. The method of claim 11 comprising receiving third visual data of a line of customers from a third camera, the line comprising the customer.

15. The method of claim 11 comprising:
receiving transaction data associated with the customer;
determining demographic information of the customer based on the first visual data;
associating the first sentiment data with the transaction data; and
associating the demographic information with the transaction data.
